(19) United States
(12) Patent Application Publication
(10) Pub. No.: US 2014/0016795 A1
(43) Pub. Date: Jan. 16, 2014

(54) PERSONALIZED HEADPHONES AND METHOD OF PERSONALIZING AUDIO OUTPUT

(71) Applicant: Barak MELAMED, Petach Tikva (IL)

(72) Inventor: Barak MELAMED, Petach Tikva (IL)

(73) Assignee: CLOSEOUT SOLUTIONS, LLC, Fair Lawn, NJ (US)

(21) Appl. No.: 13/545,298

(22) Filed: Jul. 10, 2012

(51) Int. Cl. H04R 3/00

(52) U.S. Cl. CPC H04R 3/00
USPC 381/74; 381/103

(57) ABSTRACT

The disclosure relates to a personalized headphone comprising a first speaker and a second speaker; a cord, having a removable connector plug at a distal end adapted to maintain audio communication with the first speaker and/or the second speaker, wherein the cord comprises an audio device connector plug adapted to maintain electrical communication with a digital playback device, wherein the audio output of the speakers has a built-in preconfigured equalizer personalized to a user's; age, audio file format, audio file data encoding rate and music genre.

### BACKGROUND

The disclosure relates to personalized headphones and method of personalizing audio output, specifically, the disclosure relates to headphones having speakers having optimized output personalized to the user's digital music library.

As of late, the most frequent music listening experience is based on digitally downloaded audio files, which have been encoded or compressed, at various data rates leading in some cases to lossy compression where, to reduce the amount of data stored (or streamed for downloading), some of the data is discarded (“lost”). The discarded data is often based on various algorithms of perceived psychoacoustic acuity. For example, compression at 128 kbps can result in the elimination of certain high frequencies, which when combined with certain music genres may lead to a significant alteration of the dynamic output of the speaker. When a user listens to music in an attempt to compensate for any losses, they may be forced to turn down the volume when the music causes a vulnerable frequency bands to reach their distortion power threshold.

To reduce distortion in a speaker the current approach is maintaining the power levels of vulnerable frequency bands below the distortion power threshold. For the purposes of this disclosure, the distortion power threshold for a given frequency band is the amount of power in the given frequency band the speaker can tolerate before the distortion becomes unacceptable for a particular audio application. A speaker's vulnerable frequency bands are frequency bands that have particularly low distortion power thresholds that may be exceeded during speaker use in a particular genre of music.

Some playback applications and/or devices may allow the user to apply an equalizer during the playback. The user is usually provided with sliders controlling the attenuation or gain of a frequency range usually depicted by a center frequency shown by labels. Typically, the equalizers can comprise a collection of band pass filters centered at a center frequency. The sliders allow the user to adjust the attenuation provided by the band pass filter.

While providing the end user an equalizer allows the user to tune the output to avoid distortion without necessarily turning down the overall volume, this approach has significant shortcomings. First, the bandwidth of the filter controlled by each slider is often too broad so attenuating the vulnerable frequency band has a significant impact on other frequencies negatively impacting the quality of the playback. Second, due to the nature of music, every song or composition has a different frequency profile. A given song may require attenuation to prevent a vulnerable frequency band from exceeding the distortion power threshold while a second song may not, so either the user has to readjust the equalizer or the second song, or it is unnecessarily altered. Also, the user's audio file libraries may be comprised of different digitally encoded data, leading to varying degree of loss at various frequencies. Likewise, the age and/or other health factors may impact the user's ability to hear certain frequencies.

Accordingly, there is a need for personalized, both in terms of the physical aspects, as well as music specific, audio output device.

### SUMMARY

In an embodiment, provided herein is a personalized headphone comprising a first speaker and a second speaker; a cord, having a removable connector plug at a distal end adapted to maintain audio communication with the first speaker and/or the second speaker, wherein the cord comprises an audio device connector plug adapted to maintain electrical communication with a digital playback device, wherein the audio output of the speakers has a built-in preconfigured equalizer personalized to a user's; age, audio file format, audio file data encoding rate and music genre.

In another embodiment, provided herein is a method of personalizing an audio output device comprising: using a computer in connection with a network, obtaining user data; based on the user data, preconfiguring an equalizer or DSP to provide specific power output at a specific frequency band, forming a preconfigured equalizer or DSP; operably coupling the preconfigured equalizer or DSP to a speaker, forming a built-in preconfigured equalizer speaker; and operably coupling the speaker to the audio output device.

### BRIEF DESCRIPTION OF THE FIGURES

Further features and advantages of the present technology will become apparent to those of skill in the art in view of the detailed description of preferred embodiments which follows, when considered together with the attached drawings in which:

FIG. 1 shows an exploded view of an embodiment of the headphone device;

FIG. 2 shows an example of a 31 band frequency attenuation profile for Rock Genre; and

FIG. 3 shows an example of a 31 band frequency attenuation profile for Pop Genre.

### DETAILED DESCRIPTION

In recent years, most of listening to music as well as other to audio recordings (e.g. audio books), is based on downloaded digitized data files. To reduce the amount of data transferred (bandwidth) and stored on any remote device, the digitized data files are commonly encoded or compressed. Although lossy audio compression algorithms result in higher compression (i.e. less storage space and necessary transmission bandwidth), the resulting fidelity, namely the accuracy at which the compressed audio file represents the original non-encoded file, is compromised. These algorithms rely almost entirely on perceived, normalized psychoacoustics to eliminate less audible or meaningful sounds, thereby reducing the space required to store or transmit them.

Audio coding refers to the application of data compression to audio signals such as music and speech signals. In audio coding, a “coder” encodes an input audio signal into a digital bit stream for transmission or storage, and a “decoder” decodes the bit stream into an output audio signal. The combination of the coder and the decoder is called a “codec.” The goal of audio coding is usually to reduce the encoding bit rate while maintaining a certain degree of perceptual audio quality. For this reason, audio coding is sometimes referred to as “audio compression.”

The audio files are stored at the user's device, such as a computer personal digital assistant, smartphone or a remote (cloud) server. It is contemplated that any storage device format having network connection could be used to supply the necessary data to provide the speakers and personalized headphones and other audio output device according to the disclosed devices and methods.

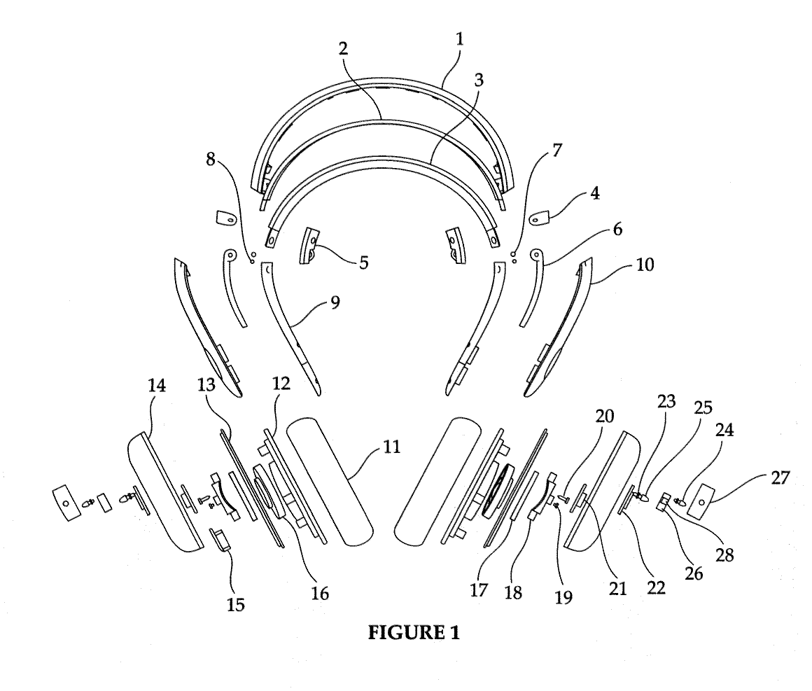

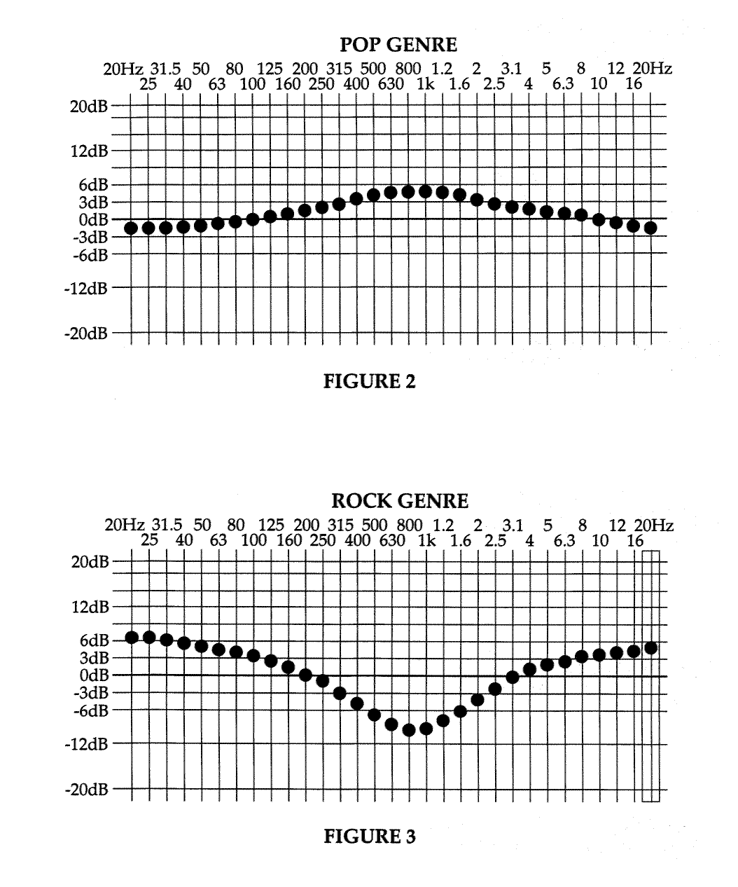

Encoding at the various data compression rates can result in different frequencies in the audible range (of between about 20 Hz to 20 kHz) being modulated to a different degree. For example, recordings using MP3 codec at data compression rates of 128 kbps result in certain high frequencies being eliminated. Likewise, various music genres will produce markedly different sound pressure at the same frequency. For example, the difference in the sound pressure at 800 Hz between Pop and Rock Genres (See FIGS. 1 and 2). All these factors, as well as the user's physical auditory condition will affect the final auditory output perceived by the user.

Accordingly, provided herein is a personalized headphone comprising a first speaker and a second speaker; a cord, having a removable connector plug at a distal end adapted to maintain audio communication with the first speaker and/or the second speaker, wherein the cord comprises an audio device connector plug adapted to maintain electrical communication with a digital playback device, wherein the audio output of the speakers has a built-in preconfigured equalizer personalized to a user's; age, audio file format, audio file data encoding rate and music genre.

Equalization is used to alter the frequency response of an audio system to enhance the listening experience. For example, output transducers, speakers and headphones have varied frequency responses. The defects in the frequency response of the output transducer can be compensated for by selectively attenuating or applying gain to the signal at particular frequencies. Equalizers can be implemented algorithmically, or through the use of passive or active electrical components. If engaged, a multiple band equalizer module can adjust amplitudes of various frequency bands to produce the representative audio signal.

It should be noted that gain and attenuation are mentioned together. Gain or attenuation can be applied to a signal to relatively suppress a portion of an audio signal. If the power level is actually reduced the signal is attenuated. If the power level is increased but not compared to other frequency bands, gain is applied, but relatively speaking the portion of the audio signal is actually suppressed. For the purposes of this disclosure, the terms applying gain or attenuation may be used interchangeably, but should be understood to mean a scaling of a portion of the audio signal relative to the rest of the audio signal.

The built in preconfigured equalizer (e.g., digital signal processor—DSP) used in the devices and methods described, or DSP module (interchangeable) can attenuate frequencies using band pass filters covering known vulnerable frequency bands or modulated filters to allow specific output. This approach can have the advantage of exploiting the knowledge of the particular frequency bands that are vulnerable for each music genre and compression rate. Moreover, the method and devices provided can optimize the center frequency per music genre thereby increasing frequency resolution. Additionally, the bandwidth of the constituent band pass filters can be narrower than that of the user adjusted equalizer, thus minimizing the impact (e.g., masking) on other frequencies and increasing frequency resolution.

The number of bands preconfigured in the equalizer and/or DSP may be limited only by the frequency resolution (e.g., frequency selectivity) of the user. For example, the preconfigured equalizer can have 5 to 101, or 9 to 90 discrete frequency bands, specifically, 13 to 65 or 19 to 57 discrete frequency bands, more specifically 25 to 45, or 27 to 39 discrete frequency bands, most specifically, 29 to 35, or 31 discrete frequency bands. the term “digital signal processor,” “signal processor” or “DSP” used above and below can mean a single DSP, multiple DSPs, a single DSP algorithm, multiple DSP algorithms, or combinations thereof.

The DSP and or preconfigured equalizer can be coupled to a digital-to-analog converter (DAC), and/or power amplifier, each or their combination which in turn can be coupled to one or more speaker in the device.

In some implementations used in the devices and methods described, a mobile playback device can also include one or more additional digital to analog converter, and/or one or more speakers to provide for additional audio output (meaning the speakers). The one or more speakers can be located on any or all of the peripheral edges, the back, and the front of the device. One or more of the included speakers, can be used to implement audio playback and/or speakerphone functionality. An accessory jack, e.g. for headphones, also can be included. Further, the playback device can have an integrated DSP that can provide for customized tuning of audio output. For example, the DSP can provide a graphic equalizer, e.g. a 31-band equalizer (or more), to allow pinpoint sound control and optimal center frequency, and a dynamics processor to provide multi-band compression and limiting. One or more preconfigured options and one or more custom options can be used to specify the audio levels for each of the equalizer's bands.

Compression of audio files in the remote device used in the devices and methods described, can be configurable using predetermined levels, e.g. off, low, medium and high, which can correspond to software configured bundles of parameters for the compressor's various level, ratio, attack and decay parameters for each band. Also, one or more frequencies that cannot be reproduced by a given output device, e.g. the integrated speaker(s), can be compensated for by the built-in preconfigured equalizer described herein. In some implementations, the DSP can be utilized for audio processing with respect to the remote device, in addition to audio playback.

The headphones used in the devices and methods described comprise a built in preconfigured equalizer or digital signal processor module which can attenuate or suppress the vulnerable frequency bands of the speaker in an audio signal. For a given speaker the intensity level in each vulnerable frequency band sufficient to cause distortion may be determined and this intensity level is referred to as the distortion power threshold. The control module receives measured signal intensities from the monitoring module and controls the equalizer to suppress the audio signal so that the intensity level in the vulnerable frequency band is lower than the intensity level sufficient to cause distortion. Additionally, the monitoring module can measure the signal before equalization or after equalization in a feedback configuration.

The user's file library containing the digitized audio files used in the devices and methods described can contain container files, which refers a computer file format that can contain various types of data, compressed by means of standardized codecs. The container file is used to identify and interleave the different data types. Simpler container formats can contain different types of audio codecs, while more advanced container formats can support audio, video, subtitles, chapters, and meta-data (tags)—along with the synchronization information needed to play back the various streams together. The audio files, can have a format such as PCM, DPCM, ADPCM, AAC, RAW, DM, RIFF, WAV, BWF, AIFF, AU, SND, CDA, MPEG, MPEG-1, MPEG-2, MPEG-2.5, MPEG-4, MPEG-J, MPEG 2-ACC, MP3, MP3Pro, ACE, MACE, MACE-3, MACE-6, AC-3, ATRAC, ATRAC3, EPAC, Twin VQ, VQF, WMA, WMA with DRM, DTS, DVD Audio, SACD, TAC, SHN, OGG, Ogg Vorbis, Ogg Tarkin, Ogg Theora, ASF, LQT, QDMC, A2b, .ra, and Real Audio G2, RMX formats, Fairplay, Quicktime, SWF, PCA, or a combination comprising at least one of the foregoing. In addition, the data in the container files can be encoded using a codec of a formt such as Cinepak, Joint Photographic Experts Group (JPEG) standards, Moving Picture Experts Group (MPEG)-1, MPEG-2, MPEG-4, and MPEG-4, MPEG-1 Audio Layer 3 (MP3), Advanced Audio Coding (AAC), High Efficiency-AAC (HE-AAC), enhanced AAC plus (eAAC+), low delay AAC (LD-AAC), International Telecommunication Union Telecommunication Standard Sector (ITU-T) audio standards, Audio Video Standard (AVS), The 3^{rd} Generation Partnership Project (3GPP) audio codec standards, 3D MPEG surround, unified speech and audio coding (USAC), Free Lossless Audio Codec (FLAC), or combinations thereof. In a specific example, the data container file format is MP3pro encoded using MP3 codec.

Music Genres used in the devices and methods described, for which the headphones can be personalized, can be Rock, Pop, R&B, Latin, Jazz, Hip-Hop, Classical, Electronic, Dance, House, Acoustic, Country, New Age, Rap, World, or Musicals. Likewise, the built in preconfigured equalizer can be personalized for a combination of genres, for example, 2-6 genres or 2-5 genres, specifically 2-4 genres, more specifically, 3 genres. Accordingly, in one embodiment, the built in preconfigured equalizer or equalizer module is configured to maximize dynamic response at a fixed sound pressure for a music library determined to comprise a majority of Rock, Pop, and Dance genre music. The maximizing of dynamic response can be done, for example, by averaging the genre-specific sound pressure at each of the frequency bands. (See e.g. FIGS. 2 and 3).

The file used in the devices and methods described, can be encoded at a bitrate of 128 kbps, 160 kbps, 192 kbps, 256 kbps, 320 kbps or more than about 320 kbps for example. In an embodiment, the term “bitrate” refers to the transfer bitrate for which the files are encoded—i.e. an MP3 codec file encoded “at a bitrate of 128 kbps” is compressed such that it could be streamed continuously through a link providing a transfer rate of 128 thousand bits per second. In another embodiment, “bitrate” refers to the measure of how severely the files are being compressed. The lower the bitrate, the more the file has been compressed. Likewise, the more compressed a file, the more of the original data is lost, and so the worse the playback sound quality can be.

In addition, user's age can be used in configuring the devices and is a part of the methods described. Hearing loss (whether age-related or otherwise), can be prevalent disorder that impairs enjoyment, learning and social interactions for millions of people. Loss of high frequency hearing usually begins in the third decade of life. This includes the most common type of hearing deficit, known as presbycusis, or age-related hearing loss. Presbycusis can be defined as progressive bilateral symmetrical age-related sensorineural hearing loss. For example, the 18 kHz “mosquito” tone, used sometimes to alert adolescents that a cell phone message has arrived, cannot be heard by many people in their 20's.

When listening to audio systems, such as headphones, those with hearing loss find they may need to adjust the output sound volume of certain frequencies in order to sufficiently hear the sounds at the frequencies for which they are hearing impaired, for example, high-pitched tones. Otherwise, the hearing impaired listener may “miss” or in other words lose some words and tones, especially the high notes. This loss interferes with communication and enjoyment of music and other sounds and can be ameliorated using the methods and devices provided.

As indicated, loss of high frequency hearing begins in the third decade of life. This includes the most common type of hearing deficit, known as presbycusis, or age-related hearing loss, for example, the 18 kHz “mosquito” tone cannot be heard by many people in their 20's. With aging, the threshold hearing sound pressure of 20 μPa RMS may increase, which can result in a significant change to the equal loudness contour of the listener (i.e. the measure of sound pressure (dB SPL), over the frequency spectrum, for which a listener perceives a constant loudness when presented with pure steady tones). Accordingly, it is contemplated that based on the user's age as used in the devices and methods described, a louder volume at each frequency band may be provided, while reducing distortions. Therefore, user age data used in the methods and devices described can further comprise: providing a discrete frequency hearing analysis to the user; determining hearing threshold at each discrete frequency; and outputting audio signals at an adjusted volumes based on the determined thresholds per frequency band.

The personalized preconfigured built in equalizer or DSP module is incorporated in a headphone attached to a playback device. The headphones further comprise a first chamber wherein the first speaker (coupled to a DSP or the personalized built-in preconfigured equalizer) is positioned in at least a portion of said chamber, said first speaker having a first audio output in audio communication with said chamber; a first tube having a proximal end in audio communication with said first chamber and a distal end in audio communication with a user's ear; and the second speaker positioned in at least a portion of a second chamber, said second speaker having a second audio output in audio communication with said chamber; a second tube having a proximal end in audio communication with said second chamber and a distal end in audio communication with a user's ear. The tubes can have variable diameter and be further coupled to a cushioning material such as foam. The foam can act as a sound isolator when the tube is configured to fit within the ear canal of the user. It is further noted, that all components of the headphones described are removable and interchangeable. In a specific example, the DSP or the personalized built-in preconfigured equalizer, operably coupled to the speaker, is capable of being interchangeably removed and replaced with a different DSP or the personalized built-in preconfigured equalizer, operably coupled to a different speaker, with different personalized audio output, without having to change other components of the headphones. The first and/or second tube in audio communication with a user's ear is adapted to fit over the user's ear, or in the user's ear canal.

Accordingly, in one embodiment, a headphone containing a DSP or the personalized built-in preconfigured equalizer, operably coupled to speaker which was based on a 60 years old user, from a music library where majority of MP3 files encoded with MP3 codec using compression at 128 kbps of Jazz and World genre music; can obtain a different DSP or the personalized built-in preconfigured equalizer, operably coupled to a speaker which was based on a 64 years old user (same user, 4 years later), from a music library where majority of MP3 files encoded with FLAC codec of Jazz, Classic and World genre music; and all without changing any other component in the headphones.

In an embodiment, provided herein is a method of personalizing an audio output device, such as, for example, headphones or speaker housing, comprising: using a computer in connection with a network, obtaining user data; based on the user data, preconfiguring an equalizer or DSP to provide specific power output at a specific frequency band, forming a preconfigured equalizer or DSP; operably coupling the preconfigured equalizer or DSP to a speaker, forming a built-in preconfigured equalizer speaker; and operably coupling the speaker to the audio output device.

The step of obtaining user data in the methods described herein can comprise the steps of selectively communicating between (1) a user remote device and (2) an online based server, the online based server accessible via a URL address; receiving data input (e.g. user age) at the remote device to establish the two-way direct connection; sending from the remote device to the online based server a request to personalize audio output, wherein the request comprises authentication information (e.g. user defined name and password) and access permission (i.e. from the user) for the online server to the remote device digital music file library (e.g. the MP3 files specifically defined by the user); authenticating the remote device by the online based server; receiving a response at the remote device to the request from the online based server, the response containing data input questioner, in other words, an on-line form, if the remote device is authenticated and access to the digital music file library is granted (e.g. for digital audio file format; digital audio file encoding rate; and music genre, which are obtained by the online server without user intervention); directly connecting the remote device to the online server using the connection information; and maintaining the two-way direct connection between the remote device and online server, for example, for the duration of the personalizing process and until a determionation is made by the remote server of the optimal preconfigured DSP (or the personalized built-in preconfigured equalizer). An additional outcome can be redirecting the remote device to a web page detailing the recommended preconfigured DSP or equalizer speaker.

The term “authentication information” may refer to an ID, a password, or a digital certificate, a combination thereof, or the like. The authentication information may be sent from the remote device to the online server to enable the online server to establish a connection with the remote device. If the authentication information stored on the remote device for the online server matches the authentication information transmitted from the online server to the remote device, the remote device may permit the online server to connect therewith and access the library.

The term “coupled”, including its various forms such as “operably coupling”, “coupling” or “couplable”, refers to and comprises any direct or indirect, structural coupling, connection or attachment, or adaptation or capability for such a direct or indirect structural or operational coupling, connection or attachment, including integrally formed components and components which are coupled via or through another component or by the forming process. Indirect coupling may involve coupling through an intermediary member or adhesive, or abutting and otherwise resting against, whether frictionally or by separate means without any physical connection. The term “operably couple” or “operably coupled” as may be used herein, includes direct coupling and indirect coupling via another component, element, circuit, or module where, for indirect coupling, the intervening component, element, circuit, or module does not modify the information of a signal but may adjust its current level, voltage level, and/or power level. As a skilled artisan will also appreciate, inferred coupling (i.e., where one element is coupled to another element by inference) includes direct and indirect coupling between two elements in the same manner as “operably coupled”.

“Dynamic response” as used herein, refers in an embodiment to the frequency range over which the speaker can effectively produce a useable and fairly uniform, undistorted output signal. Maximizing dynamic response, refers to the process of ensuring that the personalized headphones provide the widest frequency response relevant to the user at a given sound pressure, which is also personalized based on, inter-alia, the user's age and physical attributes.

As described herein, “audio file” can refer to a file which stores audio content in any known format. As used herein, the term “audio content” refers to organized audio signals stored in a digital format including, for example, music, a musical composition, a sound recording, a song, sounds or a sound design. An audio file format is a container format for storing audio data on a computer system. There are numerous formats for storing audio files. An audio file may have any known compression format, including, but not limited to, ISO/IEC, MPEG: MPEG-1 Layer III (known as MP3), MPEG-1 Layer II, 4-MP3 Database, UNIS Composer 669 Module, Six Channel Module, Eight Channel Module, Amiga OctaMed Mucis File, Amiga 8-Bit Sound File, Advanced Audio Coding (AAC) File, ABC Music Notation, ADPCM Compressed Audio File, WinAHX Tracker Module, Audio Interchange File (AIF) Format, Compressed Audio Interchange File (AIF), A-Law Compressed Sound Format, A-Law Compressed Sound Format, Adaptive Multi-Rate Codec, Monkey's Audio Lossless Audio File, Audio File, Compressed Audio File, Audio Visual Research File, GarageBand Project, CD Audio Track, Audition Loop, Creative Music Format, Cakewalk SONAR Project, OPL2 FM Audio File, OPL2 FM Audio File, Digital Speech Standard (DSS) File, Sony Digital Voice File, Eyemail Audio Recording, Farandole Composer Module, Free Lossless Audio Codec, FruityLoops Project, IC Recorder Sound File, Interchangeable File Format, Impulse Tracker Module, Karaoke MIDI File, Kinetic Music Project, Kinetic Project Template, Logic Audio Project, MP3 Playlist, MPEG-4 Audio Layer File, iTunes Audio Book, Protected AAC File, Monarch Audio File, Amiga MED Sound File, MIDI File, Synthetic Music Mobile Application Format, Amiga Music Module File MPEG Layer II Compressed Audio File, MPEG Layer 3 Audio File, MPEG Audio File, Musepack Audio File, Moving Picture Experts Group 3 Layer Audio, Mobile Phone Sound File, Memory Stick Voice File, MultiTracker Module, Napster Copyright-Secured Music File, Ogg Vorbis Compressed Audio File, Perfect Clarity Audio, Pulse Code Modulation, Panasonic Voice File, Real Audio Real Audio Media, Reason ReFill Sound Bank, Rich Music Format, RIFF MIDI (RMID) File, RealJukebox Format, ScreamTracker 3 Sound File, Secure Audio File, Sound Designer II File, Sample MIDI Dump Exchange, Sound File, SoundFont 2 Bank, Sound Forge Audio, Sibelius Score Standard MIDI File, SampleVision Audio Sample Format, Sound Clip, MIDI Song File, Synclavier Program File, Synclavier Sequence File, Synclavier Sound File, 8SVX Sound File, Signed Word Audio File, ShockWave Audio, Final Music System Tracker Module, Amiga THX Tracker Music File, PSP Audio File, TrueSpeech Audio File, Unsigned Byte Audio File, Olympus Voice Recording, Vocaltec Media File, Creative Labs Audio (Voice) File, Voyetra Voice File, VoxWare Audio, Ventrilo Audio Recording, Windows WAVE Sound File, Wave Sound File, Windows Media Audio Redirect, Windows Media Audio (WMA), Cakewalk Music Project, Extended Module Audio (EMA) File, Compressed eXtended MIDI file, etc. Though most audio file formats support only one audio codec, an audio file format may support multiple codecs, as AVI does.

The disclosed methods and technologies can be implemented in connection with any computer or other client or server device, which can be deployed as part of a computer network. In this regard, the disclosed methods, devices and technologies pertain to any computer system or environment having any number of memory or storage units, and any number of applications and processes occurring across any number of storage units or volumes, which may be used in connection with processes in accordance with the disclosed techniques and technologies. The disclosed methods, devices and technologies can apply to an environment with server computers and client computers deployed in a network environment having remote or local storage.

Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments.

Moreover, those skilled in the art will appreciate that the methods, devices and technologies may be practiced with other computer system configurations and protocols. Other well known computing systems, environments, and/or configurations that may be suitable for use with the methods, devices and technologies described include, but are not limited to, personal computers (PCs), server computers, hand-held or laptop devices, multi-processor systems, microprocessor-based systems, network PCs, minicomputers, mainframe computers, smartphones, network enabled playback devices and the like.

The computing environment is supported by a variety of systems, components, and network configurations. For example, computing systems may be connected together by wired or wireless systems, by local networks or widely distributed networks (e.g., the Internet or other infrastructure which encompasses many different networks). The Internet can be described as a system of geographically distributed remote computer networks interconnected by computers executing networking protocols that allow users to interact and share information over the network(s).

Thus, the network infrastructure enables network topologies such as client/server, peer-to-peer, or hybrid architectures. A “client” can refer to a member of a class or group that uses the services of another class or group to which it is not related. Thus, in computing, a client can refer to a process, i.e., roughly a set of instructions or tasks, that requests a service provided by another program. The client process utilizes the requested service without having to “know” any working details about the other program or the service itself. A “server” is typically a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects utilized may be distributed across multiple computing devices or objects. In a client/server architecture, a client is usually a computer that accesses shared network resources provided by another computer, e.g., a server.

Client(s) and server(s) can communicate with one another utilizing the functionality provided by protocol layer(s) used in conjunction with a network such as the Internet. The Internet commonly refers to the collection of networks and gateways that utilize the Transmission Control Protocol/Internet Protocol (TCP/IP) suite of protocols, which are well-known in the art of computer networking. The HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

A more complete understanding of the components, processes, and devices disclosed herein can be obtained by reference to the accompanying drawings. These figures (also referred to herein as “FIG.”) are merely schematic representations based on convenience and the ease of demonstrating the presently disclosed devices, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

Turning now to FIG. 1, showing an embodiment of over-the ear personalized headphones. As shown in FIG. 1, headphones 100 comprise headband comprising a top part 1, made of flexible resin, for example, PC; a middle part, 2 made of flexible resin, for example, PE and a lower part 3, made of flexible resin, for example, TPE. A lock 4, on both sides of the headband, couples the headband (1+2+3) to a decoration plate 5 that is connected to a retraction plug 6, operably coupled through a first retraction boss 7 and a second retraction boss 8, between an inner hanger part 9, and an outer hanger part 10. Each hanger part is coupled to an ear assembly comprising an ear pad 11, made of resin, for example, Poly(urethane) and memory foam, covering a removably changeable speaker assembly comprising front speaker cover 12, disposed in front of speaker 16 and optionally backed by decoration ring 13. Speaker 16 has a fixing means 17, for example a washer, coupled to a coupler 18, having for example screwing means such as interrupted tread or the like, coupler 18 containing couplers 19, 20, wherein coupler 18 is in electronic communication with a 3.5 mm jack 15. Speaker assembly is covered in the back by speaker back cover 14. Back cover 14 has a second coupler 21, configured to operably removably couple to coupler 18, and is connected through back speaker cover 14, to coupling member 22, having contractor 23 disposed thereon enabling audio and/or electronic communication with inner hosing 26 of removable cable coupler through female contractor 24 disposed within lower housing 27, with washer 28 configured to engage bising means (e.g., spring) 25.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” and/or “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It will be understood that various details of the presently disclosed subject matter may be changed without departing from the scope of the subject matter disclosed herein. Accordingly, various changes and modifications may be made to the above-described arrangements without departing from the spirit and scope of the invention, as defined by the appended claims.

I claim:

1. A personalized headphone comprising a first speaker and a second speaker; a cord, having a removable connector plug at a distal end adapted to maintain audio communication with the first speaker and/or the second speaker, wherein the cord comprises an audio device connector plug adapted to maintain communication with a digital playback device, wherein the audio output of the speakers has a built-in preconfigured equalizer personalized to a user's; age, audio file format, audio file data encoding rate and music genre.

2. The personalized headphone of claim 1, wherein said data encoding bitrate is 128 kbps, 160 kbps, 192 kbps, 256 kbps, 320 kbps or more than about 320 kbps.

3. The personalized headphone of claim 1, wherein at least one digital audio file is compressed according to a container format that is PCM, DPCM, ADPCM, AAC, RAW, DM, RIFF, WAV, BWF, AIFF, AU, SND, CDA, MPEG, MPEG-1, MPEG-2, MPEG-2.5, MPEG-4, MPEG-J, MPEG 2-ACC, MP3, MP3Pro, ACE, MACE, MACE-3, MACE-6, AC-3, ATRAC, ATRAC3, EPAC, Twin VQ, VQF, WMA, WMA with DRM, DTS, DVD Audio, SACD, TAC, SHN, OGG, Ogg Vorbis, Ogg Tarkin, Ogg Theora, ASF, LQT, QDMC, A2b, .ra, .rm, and Real Audio G2, RMX formats, Fairplay, Quicktime, SWF, or PCA.

4. The personalized headphone of claim 3, wherein at least one digital audio file is encoded using Cinepak, Joint Photographic Experts Group (JPEG) standards, Moving Picture Experts Group (MPEG)-1, MPEG-2, MPEG-4, and MPEG-4, MPEG-1 Audio Layer 3 (MP3), Advanced Audio Coding (AAC), High Efficiency-AAC (HE-AAC), enhanced AAC plus (eAAC+), low delay AAC (LD-AAC), International Telecommunication Union Telecommunication Standard Sector (ITU-T) audio standards, Audio Video Standard (AVS), The 3^{rd} Generation Partnership Project (3GPP) audio codec standards, 3D MPEG surround, unified speech and audio coding (USAC), Free Lossless Audio Codec (FLAC), or combinations thereof.

5. The personalized headphone of claim 1, wherein the built-in preconfigured equalizer has 5-81 frequency bands.

6. The personalized headphone of claim 4, wherein the frequency bands in the built-in preconfigured equalizer are between 18 Hz and 20 kHz.

7. The personalized headphone of claim 3, wherein the digital audio file is an MP3 formatted file.

8. The personalized headphone of claim 1, wherein at least one genre is Rock, R&B, Latin, Jazz, Hip-Hop, Classical, Electronic, Dance, House, Acoustic, Country, New Age, Rap, World, or Musicals.

9. The personalized headphone of claim 1, wherein the built-in preconfigured equalizer is personalized to a plurality of audio file formats, audio file data encoding rates and music genres.

10. The personalized headphone of claim 8, wherein the built-in preconfigured equalizer is personalized to a plurality of audio files having data encoding rates of 128 kbps, 160 kbps, 192 kbps, 256 kbps, 320 kbps or more than about 320 kbps and combination thereof.

11. The personalized headphone of claim 8, wherein the plurality of digital audio files are compressed in a container format that is PCM, DPCM, ADPCM, AAC, RAW, DM, RIFF, WAV, BWF, AIFF, AU, SND, CDA, MPEG, MPEG-1, MPEG-2, MPEG-2.5, MPEG-4, MPEG-J, MPEG 2-ACC, MP3, MP3Pro, ACE, MACE, MACE-3, MACE-6, AC-3, ATRAC, ATRAC3, EPAC, Twin VQ, VQF, WMA, WMA with DRM, DTS, DVD Audio, SACD, TAC, SHN, OGG, Ogg Vorbis, Ogg Tarkin, Ogg Theora, ASF, LQT, QDMC, A2b, .ra, .rm, and Real Audio G2, RMX formats, Fairplay, Quicktime, SWF, PCA, FLAC, or a combination thereof.

12. The personalized headphone of claim 11, wherein at least one digital audio file is encoded using Cinepak, Joint Photographic Experts Group (JPEG) standards, Moving Picture Experts Group (MPEG)-1, MPEG-2, MPEG-4, and MPEG-4, MPEG-1 Audio Layer 3 (MP3), Advanced Audio Coding (AAC), High Efficiency-AAC (HE-AAC), enhanced AAC plus (eAAC+), low delay AAC (LD-AAC), International Telecommunication Union Telecommunication Standard Sector (ITU-T) audio standards, Audio Video Standard (AVS), The 3^{rd} Generation Partnership Project (3GPP) audio codec standards, 3D MPEG surround, unified speech and audio coding (USAC), Free Lossless Audio Codec (FLAC), or combinations thereof.

13. The personalized headphone of claim 4, wherein the built-in preconfigured equalizer has 30 to 35 frequency bands.

14. The personalized headphone of claim 1, further comprising a first chamber wherein the first speaker is positioned in at least a portion of said chamber, said first speaker having a first audio output in audio communication with said chamber; a first tube having a proximal end in audio communication with said first chamber and a distal end in audio communication with a user's ear; and the second speaker positioned in at least a portion of a second chamber, said second speaker having a second audio output in audio communication with said chamber; a second tube having a proximal end in audio communication with said second chamber and a distal end in audio communication with a user's ear.

15. The personalized headphone of claim 12, wherein the first and/or second tube in audio communication with a user's ear is adapted to fit over the user's ear.

16. The personalized headphone of claim 12, wherein the first and/or second tube in audio communication with a user's ear is adapted to fit in the user's ear.

17. A method of personalizing an audio output device comprising:
using a computer in connection with a network, obtaining user data;
based on the user data, preconfiguring an equalizer to provide specific power output at a specific frequency band, forming a preconfigured equalizer;
operably coupling the preconfigured equalizer to a speaker, forming a built-in preconfigured equalizer speaker; and
operably coupling the speaker to the audio output device.

18. The method of claim 17, wherein the audio output device is a headphone, a speaker housing, or a combination comprising at least one of the foregoing.

19. The method of claim 17, wherein user data comprise:
age;
digital audio file format;
digital audio file encoding rate; and
music genre.

20. The method of claim 19, wherein user age data further comprises:
providing a discrete frequency hearing analysis to the user;
determining hearing threshold at each discrete frequency; and
outputting audio signals at an adjusted volumes based on the determined thresholds.

21. The method of claim 19, wherein user audio file format data is compressed in a container format that is PCM, DPCM, ADPCM, AAC, RAW, DM, RIFF, WAV, BWF, AIFF, AU, SND, CDA, MPEG, MPEG-1, MPEG-2, MPEG-2.5, MPEG-4, MPEG-J, MPEG 2-ACC, MP3, MP3Pro, ACE, MACE, MACE-3, MACE-6, AC-3, ATRAC, ATRAC3, EPAC, Twin VQ, VQF, WMA, WMA with DRM, DTS, DVD Audio, SACD, TAC, SHN, OGG, Ogg Vorbis, Ogg Tarkin, Ogg Theora, ASF, LQT, QDMC, A2b, .ra, .rm, and Real Audio G2, RMX formats, Fairplay, Quicktime, SWF, PCA, or a combination comprising at least one of the foregoing.

22. The method of claim 19, wherein at least one digital audio file is encoded using Cinepak, Joint Photographic Experts Group (JPEG) standards, Moving Picture Experts Group (MPEG)-1, MPEG-2, MPEG-4, and MPEG-4, MPEG-1 Audio Layer 3 (MP3), Advanced Audio Coding (AAC), High Efficiency-AAC (HE-AAC), enhanced AAC plus (eAAC+), low delay AAC (LD-AAC), International Telecommunication Union Telecommunication Standard Sector (ITU-T) audio standards, Audio Video Standard (AVS), The 3^{rd} Generation Partnership Project (3GPP) audio codec standards, 3D MPEG surround, unified speech and audio coding (USAC), Free Lossless Audio Codec (FLAC), or combinations thereof.

23. The method of claim 19, wherein user audio file data encoding is 128 kbps, 160 kbps, 192 kbps, 256 kbps, 320 kbps, more than about 320 kbps or a combination comprising at least one of the foregoing.

24. The method of claim 19, wherein at least one genre is Rock, R&B, Latin, Jazz, Hip-Hop, Classical, Electronic, Dance, House, Acoustic, Country, New Age, Rap, World, or Musicals.

25. The method of claim 19, wherein the preconfigured equalizer has 5-81 frequency bands.

26. The method of claim 17, wherein, based on user data, the audio output is optimized to provide maximum dynamic response at a fixed sound pressure.

27. The method of claim 17, wherein the step of obtaining user data comprises:
selectively communicating between (1) a user remote device and (2) an online based server, the online based server accessible via an address;
receiving data input at the remote device to establish the two-way direct connection;
sending from the remote device to the online based server a request to personalize audio output, wherein the request comprises authentication information and access permission for the online server to the remote device digital music file library;
authenticating the remote device by the online based server;
receiving a response at the remote device to the request from the online based server, the response containing data input questioner if the remote device is authenticated and access to the digital music file library is granted; directly connecting the remote device to the online server using the connection information; and maintaining the two-way direct connection between the remote device and online server.

28. The method of claim 24, wherein digital audio file format; digital audio file encoding rate; and music genre are obtained by the online server without user intervention.

29. The method of claim 24, further comprising redirecting the remote device to a web page detailing the preconfigured equalizer speaker.
